(19) United States
(12) Patent Application Publication
(10) Pub. No.: US 2016/0178181 A1
(43) Pub. Date: Jun. 23, 2016

(54) ISM ARCHITECTURE ADAPTED FOR VARIABLE OPTICAL CONFIGURATIONS

(71) Applicant: BRIDGELUX, INC., Livermore, CA (US)

(72) Inventor: Robert LaDUCA, Union City, CA (US)

(21) Appl. No.: 14/964,422

(22) Filed: Dec. 9, 2015

Related U.S. Application Data
(60) Provisional application No. 62/080,240, filed on Nov. 14, 2014.

(51) Int. Cl. F21V 29/70; F21V 29/503

(52) U.S. Cl. CPC F21V 29/70; F21V 29/503; F21Y 2101/02

(57) ABSTRACT

Embodiments enable the adoption of the Integrated Smart Module (ISM) as painless as possible using a Flipped Board ISM design that provides a flat and open space on the top surface for reduced optic interference. Embodiments also allow hot components to be thermally bonded to the system's heat sink should it be required. For example, in the Flipped Board ISM design the printed circuit board assembly (PCBA) is flipped so the components are facing away from the light emitting surface (LES). This allows a flat and open area for optics to interface with while still thermally sinking the light emitting diode (LED) substrate to an external heat sink through a heat spreader.

### CROSS-REFERENCE TO RELATED APPLICATION

This application claims priority to U.S. provisional patent application No. 62/080,240 entitled “ISM ARCHITECTURE ADAPTED FOR VARIABLE OPTICAL CONFIGURATIONS,” filed Nov. 14, 2014, which is hereby fully incorporated by reference in its entirety.

### BACKGROUND

Current integrated smart module architectures include electronic components that are disposed on a circuit board and on the same side as the light engine. The problem with this architecture is that it is difficult to incorporate different optical configurations because of the layout. Therefore what is needed is an architecture that is adaptable to incorporate variable optical configurations without interfering with electronics.

### SUMMARY

Embodiments enable the adoption of the Integrated Smart Module (ISM) as painless as possible using a Flipped Board ISM design that provides a flat and open space on the top surface for reduced optic interference. Embodiments also allow hot components to be thermally bonded to the system's heat sink should it be required. For example, in the Flipped Board ISM design the printed circuit board assembly (PCBA) is flipped so the components are facing away from the light emitting surface (LES). This allows a flat and open area for optics to interface with while still thermally sinking the light emitting diode (LED) substrate to an external heat sink through a heat spreader.

### BRIEF DESCRIPTION OF THE DRAWINGS

FIG. 1 is an exploded view of a lighting assembly;

FIG. 2 is a cross sectional view of the lighting assembly;

FIG. 3 is an isometric view of a lighting assembly.

FIG. 4 is an isometric view of a heat spreader

FIG. 5 is an exemplary circuit diagram of electronic components that can be incorporated into a PCBA used in the lighting assembly.

### DETAILED DESCRIPTION

Embodiments enable the adoption of the ISM as painless as possible using a Flipped Board ISM design that provides a flat and open space on the top surface for reduced optic interference. Embodiments also allow hot components to be thermally bonded to the system's heat sink should it be required. For example, in the Flipped Board ISM design the PCBA is flipped so the components are facing away from the LES. This allows a flat and open area for optics to interface with while still thermally sinking the LED substrate to an external heat sink through a heat spreader.

FIG. 1 illustrates an exploded view of an ISM PCBA that is flipped over so the components are facing away from the LES surface allowing a flat and open area for optics that does not interfere with the electronic components in accordance with one embodiment. FIG. 1 shows a deconstructed ISM PCBA and includes a cap 110, a PCBA 112, a light engine 114, and a heat spreader 116. A completed ISM PCBA would have all these components assembled into a single unit. The ISM PCBA assembly can include a substrate having a first side, a second side and an opening. Electronic components are disposed on the first side of the substrate and a light engine is attached to the substrate on the first side and centered within the opening of the substrate. The second side of the substrate is configured to attach an optical element for directing light emitted from the light engine.

The ISM PCBA assembly can further include a heat spreader that is thermally connected to a back side of the light engine. In one embodiment the heat spreader is conical in shape. In another embodiment, the heat spreader is cylindrical in shape. In some embodiments, the heat spreader can be made of die cast aluminum.

The second side of the substrate can include a reflective surface and can include a means for attaching an optical component. For example the means can be mounting holes. The heat spreader can also be configured to attach to a heat sink. The ISM PCBA assembly can also further include a thermal conductor configured to directly couple at least one of the electronic components to a heat sink.

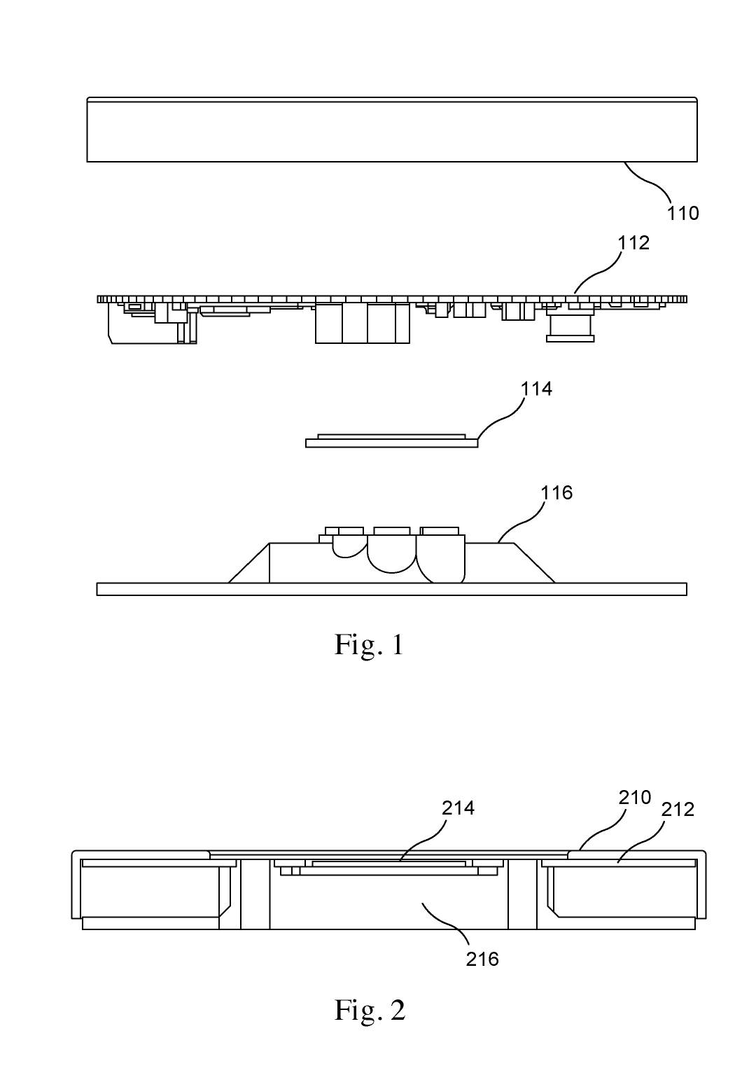

FIG. 2 illustrates a cross sectional view of the stack up of the assembly. It includes a cap 210, a PCBA 212, a light engine 214, and a heat spreader 216. In some embodiments, the area between the PCBA 212 and the heat spreader 216 is filled with a thermally conductive material for improved additional thermal relief. Although the electronic components are omitted from FIG. 2 to reduce image clutter, the electronic components are included in the PCBA 212, as understood by those skilled in the art.

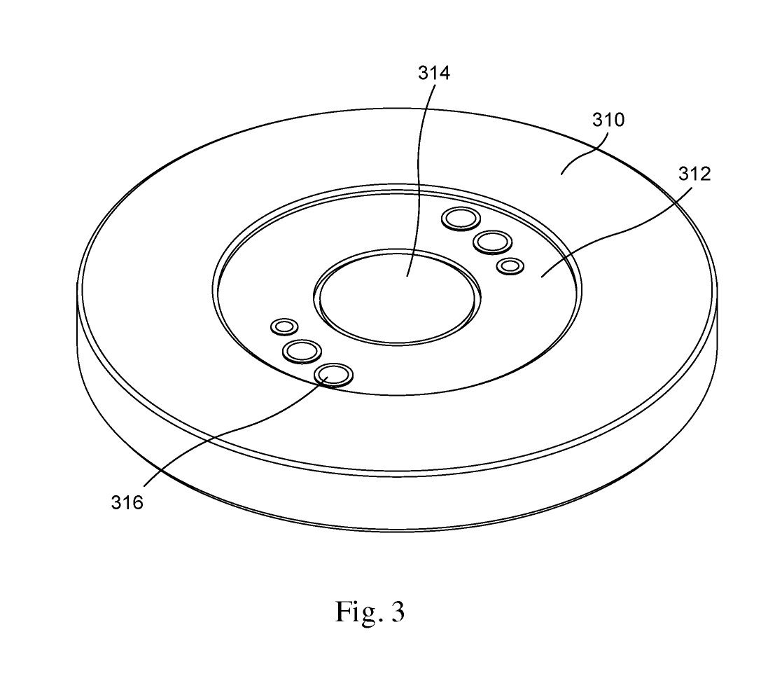

FIG. 3 Illustrates an Isometric view of the ISM PCBA assembly to highlight how a components cap 310, a PCBA 312, a light engine 314, and a heat spreader 316 are connected. The mounting holes are positioned on top of the ISM PCBA assembly. The dimensions of the ISM PCBA assembly as well as mounting hole placement are variable to improve optic component compatibility.

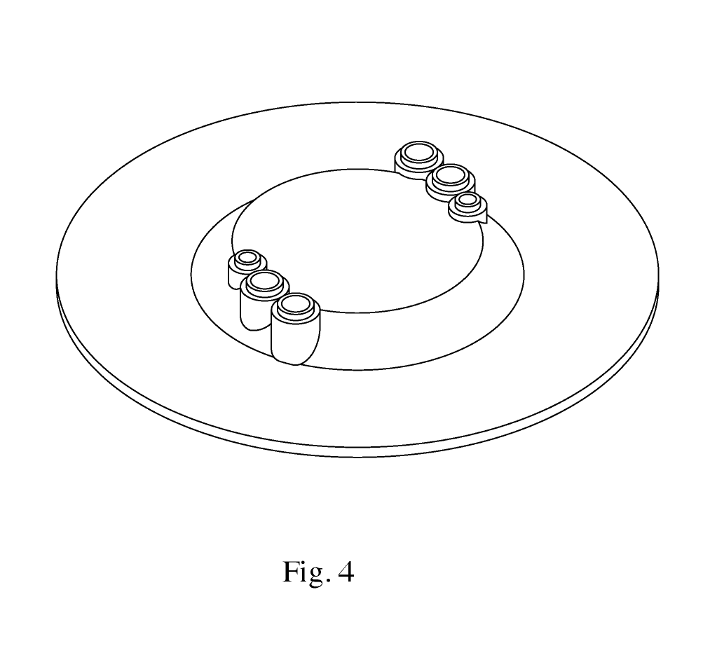

FIG. 4 illustrates the heat spreader that is thermally bonded to the base of the light engine substrate. It provides space for the electronic components while still allowing heat from the LED substrate to be dissipated. Should one of the components in the PCBA require thermal relief one or more standoffs can be added to the heat spreader design to thermally bond the component to an external heat sink. The heat spreader also acts as a load bearing part to remove stress from the PCBA when installed.

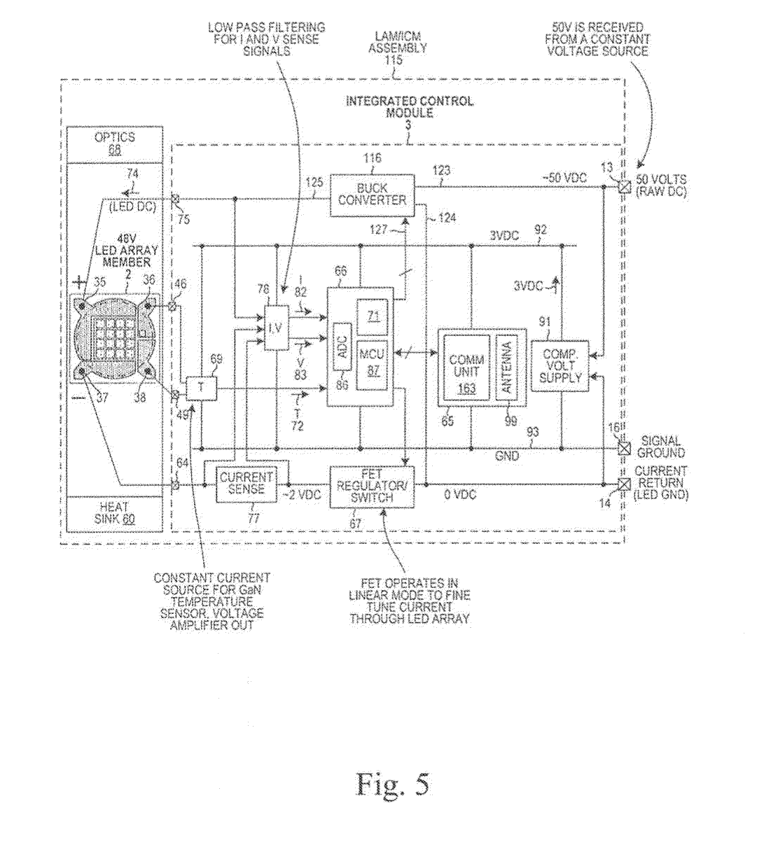

FIG. 5 is an exemplary circuit diagram of electronic components that can be incorporated into a PCBA used in the lighting assembly in accordance with another embodiment. The ISM PCBA assembly is illustrated with the heat sink 60 and with optics 68 denoted as blocks. The microcontroller 66 monitors the temperature of the LED array member (LAM) 2 via a temperature interface circuit 69. Temperature interface circuit 69 includes a constant current source that supplies a constant current 70 to the temperature sensing GaN die 32 via ISM contact pad 46, LAM contact pad 36, LAM contact pad 38 and ISM contact pad 49. The temperature interface circuit 69 also includes a voltage amplifier that amplifies the sensed voltage across LAM contact pads 36 and 38 and supplies the resulting amplified voltage signal T 72 to the microcontroller 66 via conductor 73. In addition, microcontroller 66 monitors the voltage V with which the LEDs of LAM 2 are driven. This LED drive voltage is the voltage between LAM contact pads 35 and 37. A current and voltage measuring interface circuit 78 measures this voltage via conductors 79 and 80. In addition, microcontroller 66 monitors the LED drive current 74 flowing through the LEDs of the LAM 2. This current 74 flows from pin 13, through ISM contact pad 75, through LAM contact pad 35, through the LEDs, through LAM contact pad 37, through ISM contact pad 64, through current sense resistor 77, through FET switch 67, out of the LAM/ISM assembly via pin 14. The current and voltage measuring interface circuit 78 detects the LED drive current 74 as the voltage dropped across the current sense resistor 77. This voltage is detected across conductors 80 and 81. The voltage and current measuring interface circuit 78 receives the voltage sense and current sense signals, low pass filters them, amplifies them, and performs level shifting and scaling to generate a voltage sense signal V 82 and a current sense signal I 83. The voltage and current sense signals 82 and 83 are supplied to the microcontroller 66 via conductors 84 and 85, respectively.

The T signal 72, the V signal 82, and the I signal 83 are converted into digital values by the analog-to-digital converter (ADC) 86 of the microcontroller. A main control unit (MCU) 87 of the microcontroller executes a program 71 of processor-executable instructions. The I, V and T signals, as well as information received from communication integrated circuit 65, are used by the MCU 87 to determine how to control FET switch 67. In the present example, the MCU 87 can control the FET switch to be nonconductive, thereby turning off the LEDs. The MCU 87 can control the FET switch to be fully conductive, thereby turning on the LEDs to a brightness proportional to the current supplied by the AC-DC converter as controlled by the zero to ten volt signal also produced by the MCU as directed by the control program. As explained in further detail below, the ISM 3 receives a substantially constant current via pins 13 and 14 from an AC-to-DC power supply circuit 88. The AC-to-DC power supply circuit 88 has a constant current output, the magnitude of the constant current being controllable by a zero to ten volt signal received by the AC-to-DC power supply circuit. The voltage that results across pins 13 and 14 when this constant current is being supplied to the LAM/ISM assembly 1 is about 50 volts. The microcontroller 66 controls the FET switch 67 to be fully on with nearly zero voltage across it when the LAM is to be illuminated. To accomplish control for a desired LED brightness (desired amount of current flow through the LEDs of the LAM), the microcontroller 66 sends a zero to ten voltage dimming control signal 89 back to the AC-to-DC power supply circuit 88 via conductor 90, and data terminal 15. The microcontroller 66 uses this control signal 89 to increase and to decrease the magnitude of the constant current 74 being output by the AC-to-DC power supply circuit 88. The circuit components 69, 78, 66 and 65 are powered from a low DC supply voltage such as 3 volts DC. A component voltage supply circuit 91 generates this 3 volt supply voltage from the 50 volts across pins 13 and 14. The 3 volt supply voltage is supplied onto voltage supply conductor 90. Conductor 93 is the ground reference conductor for the component supply voltage. Because only a small amount of power is required to power the circuitry embedded in the ISM, the component voltage supply circuit 91 may be a simple linear voltage regulator.

What is claimed is:

1. A lighting assembly comprising:
a substrate comprising a first side a second side and an opening;
a plurality of electronic components disposed on the first side of the substrate:
a light engine attached to the substrate on the first side and centered within the opening of the substrate:
wherein the second side of the substrate is configured to attach an optical element for directing light emitted from the light engine.

2. The light assembly of claim 1 further comprising a heat spreader thermally connected to a back side of the light engine.

3. The light assembly of claim 2 wherein the heat spreader is conical.

4. The light assembly of claim 2 wherein the heat spreader is cylindrical.

5. The light assembly of claim 2 wherein the heat spreader is a die cast aluminum.

6. The light assembly of claim 1 wherein the second side of the substrate comprises a reflective surface.

7. The light assembly of claim 1 wherein the second side of the substrate comprises a means for attaching an optical component.

8. The light assembly of claim 2 wherein the heat spreader is configured to attach to a heat sink.

9. The light assembly of claim 1 further comprising a thermal conductor configured to directly couple at least one of the electronic components to a heat sink.
